(19) United States
(12) Patent Application Publication
(10) Pub. No.: US 2018/0038359 A1
(43) Pub. Date: Feb. 8, 2018

(54) VARIABLE-DISPLACEMENT SWASH PLATE-TYPE COMPRESSOR

(71) Applicant: KABUSHIKI KAISHA TOYOTA JIDOSHOKKI, Aichi-ken (JP)

(72) Inventors: Kazunari HONDA, Kariya-shi (JP); Hisaya KONDO, Kariya-shi (JP); Shinya YAMAMOTO, Kariya-shi (JP); Takahiro SUZUKI, Kariya-shi (JP); Kei NISHII, Kariya-shi (JP); Shohei FUJIWARA, Kariya-shi (JP)

(73) Assignee: KABUSHIKI KAISHA TOYOTA JIDOSHOKKI, Aichi-ken (JP)

(21) Appl. No.: 15/554,154

(22) PCT Filed: Feb. 23, 2016
(86) PCT No.: PCT/JP2016/055241

§ 371 Date: Aug. 28, 2017

(30) Foreign Application Priority Data
Mar. 4, 2015 (JP) 2015-042620

(51) Int. Cl. F04B 27/18; F16C 17/10

(52) U.S. Cl. CPC F04B 27/1804; F16C 17/10; F04B 27/1045

(57) ABSTRACT

A pressure-acting chamber is defined by a first cylinder block and a spacer. The pressure-acting chamber communicates with a discharge chamber via a supply passage. A load based on the pressure difference between the pressure-acting chamber and a swash plate chamber is applied to a rotary shaft and acts toward a second thrust bearing.

### TECHNICAL FIELD

The present invention relates to a variable displacement swash plate type compressor.

### BACKGROUND ART

For example, Patent Document 1 discloses a fixed displacement swash plate type compressor. The swash plate type compressor includes a first cylinder block, a second cylinder block, a front housing member, and a rear housing member. The first and second cylinder blocks are coupled to each other. The front housing member is coupled to the first cylinder block, and the rear housing member is coupled to the second cylinder block. The housing accommodates a rotary shaft, which is rotationally supported by the housing. One end of the rotary shaft is rotationally supported by the first cylinder block. The other end of the rotary shaft is rotationally supported by the second cylinder block.

In the housing, the first cylinder block and the second cylinder block define a swash plate chamber. The swash plate chamber accommodates a swash plate, which rotates when receiving drive force from the rotary shaft. The swash plate is inclined by a fixed inclination angle relative to the direction perpendicular to the axis of the rotary shaft.

The first cylinder block has first cylinder bores located about the rotary shaft. Also, the second cylinder block has second cylinder bores located about the rotary shaft. The first cylinder bores and the second cylinder bores extend along the axis of the rotary shaft and are arranged to form pairs. Each pair of the first cylinder bore and the second cylinder bore reciprocally accommodates a double-headed piston. Each double-headed piston is engaged with the peripheral portion of the swash plate with a pair of shoes. When the swash plate rotates together with the rotary shaft, the rotation of the swash plate is converted into linear reciprocation of the double-headed pistons by the shoes.

Thrust bearings are each arranged between the rotary shaft and the first cylinder block and between the rotary shaft and the second cylinder block. The thrust bearings are tightly held between the rotary shaft and the first cylinder block and between the rotary shaft and the second cylinder block by fastening force of the housing bolts, which fasten the first cylinder block, the second cylinder block, the front housing member, and the rear housing member together. Accordingly, the rotary shaft is tightly held by the thrust bearings in the axial direction of the rotary shaft, so that the position of the rotary shaft is determined in the axial direction.

The swash plate receives compression reaction force due to reciprocation of the double-headed pistons. Accordingly, the swash plate applies thrust to the rotary shaft. At this time, since the position of the rotary shaft is determined in the axial direction and the thrust bearings bear the thrust acting on the rotary shaft, the rotary shaft is restrained from chattering by the applied thrust.

### PRIOR ART DOCUMENT

### Patent Document

Patent Document 1: Japanese Laid-Open Patent Publication No. 7-197883

### SUMMARY OF THE INVENTION

### Problems that the Invention is to Solve

Swash plate type compressors of the above described type include variable displacement compressors, which vary the displacement. This type of compressor is configured to change the inclination angle of the swash plate, thereby causing the double-headed pistons to reciprocate by a stroke corresponding to the swash plate inclination angle. This compressor has, in the swash plate chamber, an actuator for changing the inclination angle of the swash plate. The actuator has a partition body arranged on the rotary shaft, a movable body, which moves in the swash plate chamber along the axis of the rotary shaft, and a control pressure chamber, which is defined by the partition body and the movable body. The movable body is moved along the axis of the rotary shaft by changing the pressure in the control pressure chamber. Also, as the movable body moves along the axis of the rotary shaft, the inclination angle of the swash plate is changed.

In this compressor, the compression reaction force applied to the swash plate by the double-headed pistons is increased as the displacement is increased. Accordingly, the thrust transmitted to the rotary shaft from the swash plate is increased. The fastening force in the axial direction generated by the housing bolts needs to be set at a large value so that the thrust transmitted to the rotary shaft can be borne by the thrust bearings.

However, the compression reaction force applied to the swash plate from the double-headed pistons is decreased as the displacement is decreased. Accordingly, the thrust transmitted to the rotary shaft from the swash plate is decreased. At this time, if the fastening force in the axial direction generated by the housing bolts is set to be strong, the sliding resistance between the thrust bearings and the rotary shaft is increased. This increases the power loss.

Accordingly, it is an objective of the present invention to provide a variable displacement swash plate type compressor that restrains chattering of the rotary shaft caused by thrust acting on the rotary shaft, while reducing power loss.

### Means for Solving the Problems

To achieve the foregoing objective and in accordance with a first aspect of the present invention, a variable displacement swash plate type compressor is provided that includes a housing, a rotary shaft, a thrust bearing, a swash plate chamber, a swash plate, a piston, and an actuator. The housing has a cylinder block, in which a discharge chamber and a plurality of cylinder bores are provided. The rotary shaft is rotationally supported by the housing. The thrust bearing is arranged between the cylinder block, which is arranged along an axis of the rotary shaft, and the rotary shaft. The thrust bearing bears a thrust that acts in an axial direction of the rotary shaft. The swash plate chamber is provided in the housing and draws in refrigerant from outside. The swash plate is accommodated in the swash plate chamber. The swash plate is rotated by receiving a drive force from the rotary shaft and is tiltable relative to a direction perpendicular to the axis of the rotary shaft. The piston is reciprocally received in the cylinder bores. The actuator is arranged in the swash plate chamber and configured to change an inclination angle of the swash plate. The actuator includes a partition body provided on the rotary shaft, a movable body, which is provided in the swash plate chamber and movable along the axis of the rotary shaft, and a control pressure chamber, which is defined by the partition body and the movable body. The movable body is moved by a pressure in the control pressure chamber. As the movable body moves along the axis of the rotary shaft, the inclination angle of the swash plate is changed so that the piston reciprocates by a stroke in accordance with the inclination angle of the swash plate. The rotary shaft receives a load acting toward the thrust bearing. The load is based on a pressure difference between the discharge chamber and the swash plate chamber.

With this configuration, when the displacement increases so that the pressure in the discharge chamber increases, the pressure difference between the discharge chamber and the swash plate chamber increases. This increases the load that is applied to the rotary shaft and acts toward the thrust bearing. This presses the rotary shaft against the thrust bearing, thereby fixing the position in the axial direction of the rotary shaft. Thus, even if an increase in the displacement increases the compression reaction force applied to the swash plate from the piston so that the thrust applied to the rotary shaft from the swash plate is increased, the rotary shaft is restrained from chattering due to the applied thrust since the position of the rotary shaft is fixed in the axial direction. In contrast, the compression reaction force applied to the swash plate from the piston is decreased when the displacement is decreased. Accordingly, the thrust transmitted to the rotary shaft from the swash plate is decreased. At this time, since the pressure in the discharge chamber is lowered due to the decrease in the displacement, the pressure difference between the discharge chamber and the swash plate chamber decreases. This reduces the load that is applied to the rotary shaft and acts toward the thrust bearing. Therefore, the sliding resistance between the thrust bearing and the rotary shaft is reduced, which reduces the power loss. From the above, it is possible to restrain chattering of the rotary shaft caused by the thrust acting on the rotary shaft, while reducing the power loss.

In the above described variable displacement swash plate type compressor, a spacer is preferably arranged between the cylinder block, which is arranged along the axis of the rotary shaft, and the rotary shaft. The spacer is supported by the rotary shaft while being restricted from rotating and allowed to move along the axis of the rotary shaft. The cylinder block and the spacer preferably define a pressure-acting chamber, which communicates with the discharge chamber. A sealing member is preferably arranged between the spacer and the cylinder block. The sealing member seals off the pressure-acting chamber and the swash plate chamber from each other.

With this configuration, since the spacer is restricted from rotating with respect to the rotary shaft, the durability of the sealing member is improved as compared with a case where the spacer rotates integrally with the rotary shaft. Accordingly, the sealing performance between the pressure-acting chamber and the swash plate chamber is improved.

In the above described variable displacement swash plate type compressor, a spacer is preferably provided on the rotary shaft to be integrally rotational with the rotary shaft, and the cylinder block and the spacer preferably define a pressure-acting chamber, which communicates with the discharge chamber. A sealing member is preferably arranged between the spacer and the cylinder block. The sealing member seals off the pressure-acting chamber and the swash plate chamber from each other.

With this configuration, since the spacer is allowed to rotate integrally with the rotary shaft, there is no need to provide a thrust bearing between the spacer and the rotary shaft, so that the number of components is reduced. This reduces the weight of the variable displacement swash plate type compressor.

In the above described variable displacement swash plate type compressor, the spacer preferably has a contact portion, which contacts the cylinder block and is located in a vicinity of the cylinder block that is located in the axial direction of the rotary shaft.

With this configuration, when the housing is assembled, the fastening force acting on the housing in the axial direction of the rotary shaft generates a load that acts toward the thrust bearing from the cylinder block via the contact portion. As a result, the rotary shaft is pressed against the thrust bearing, so that the position of the rotary shaft is determined in the axial direction. Therefore, for example, even when the operation of the variable displacement swash plate type compressor is stopped and the rotary shaft is not receiving the load based on the pressure difference between the discharge chamber and the swash plate chamber, the positioning of the rotary shaft in the axial direction is ensured. Therefore, for example, even if the vehicle in which the variable displacement swash plate type compressor is installed vibrates and causes the compressor to vibrate, the rotary shaft is restrained from chattering in the axial direction.

In the above described variable displacement swash plate type compressor, the housing preferably includes a pair of cylinder blocks, and the pair of cylinder blocks preferably each have a cylinder bore. The cylinder bores form a pair. The pair of the cylinder bores reciprocally accommodates a double-headed piston, which is the piston. The double-headed piston defines a first compression chamber in one of the pair of the cylinder bores and a second compression chamber in the other one of the pair of the cylinder bores. A link mechanism is arranged between the rotary shaft and the swash plate. The link mechanism allows change of the inclination angle of the swash plate with respect to a direction that is perpendicular to the axis of the rotary shaft. The link mechanism is arranged such that, as the inclination angle of the swash plate is changed, a top dead center position of the double-headed piston in the second compression chamber is displaced by a greater amount than a top dead center position of the double-headed piston in the first compression chamber. A direction of a compression reaction force acting on the swash plate from the double-headed piston in the first compression chamber is the same as a direction of the load applied to the rotary shaft based on the pressure difference between the discharge chamber and the swash plate chamber.

When the dead volume of the second compression chamber is increased to a predetermined value due to reduction in the inclination angle of the swash plate, the double-headed piston no longer performs the discharge stroke in the second compression chamber. Then, the compression reaction force applied to the swash plate from the part of the double-headed piston in the first compression chamber exceeds the compression reaction force applied to the swash plate from the part of the double-headed piston in the second compression chamber. At this time, the direction of the compression reaction force acting on the swash plate from the part of the double-headed piston in the first compression chamber is the same as the direction of the load applied to the rotary shaft based on the pressure difference between the discharge chamber and the swash plate chamber. This permits reduction in the load required to press the rotary shaft against the thrust bearing, that is, reduction in the load applied to the rotary shaft based on the pressure difference between the discharge chamber and the swash plate chamber. This efficiently reduces chattering of the rotary shaft caused by the thrust acting on the rotary shaft.

In the above described variable displacement swash plate type compressor, an outer diameter of a head of the double-headed piston accommodated in one of the pair of the cylinder bores is preferably larger than an outer diameter of a head of the double-headed piston accommodated in the other cylinder bore of the pair.

With this configuration, the compression reaction force applied to the swash plate from the part of the double-headed piston in the first compression chamber is greater than in the case in which the outer diameter of a head of the double-headed piston accommodated in one of the pair of the cylinder bores is the same as or smaller than the outer diameter of the other head of the piston accommodated in the other cylinder bore. This further reduces the load required to press the rotary shaft against the thrust bearing, that is, the load applied to the rotary shaft based on the pressure difference between the discharge chamber and the swash plate chamber. Thus, the chattering of the rotary shaft caused by the thrust acting on the rotary shaft is more efficiently reduced.

To achieve the foregoing objective and in accordance with a second aspect of the present invention, a variable displacement swash plate type compressor is provided that includes a housing, a rotary shaft, a thrust bearing, a swash plate chamber, a swash plate, a piston, and an actuator. The housing has a cylinder block, in which a discharge chamber and a plurality of cylinder bores are provided. The rotary shaft is rotationally supported by the housing. The thrust bearing is arranged between the cylinder block, which is arranged along an axis of the rotary shaft, and the rotary shaft. The thrust bearing bears a thrust that acts in an axial direction of the rotary shaft. The swash plate chamber is provided in the housing and draws in refrigerant from outside. The swash plate is accommodated in the swash plate chamber. The swash plate is rotated by receiving a drive force from the rotary shaft and is tiltable relative to a direction perpendicular to the axis of the rotary shaft. The piston is reciprocally received in the cylinder bores. The actuator is arranged in the swash plate chamber and configured to change an inclination angle of the swash plate. The actuator includes a partition body provided on the rotary shaft, a movable body, which is provided in the swash plate chamber and movable along the axis of the rotary shaft, and a control pressure chamber, which is defined by the partition body and the movable body. The movable body is moved by a pressure in the control pressure chamber. As the movable body moves along the axis of the rotary shaft, the inclination angle of the swash plate is changed such that the inclination angle of the swash plate increases when the pressure in the control pressure chamber is increased, and that the inclination angle of the swash plate decreases when the pressure in the control pressure chamber is lowered, thereby causing the piston to reciprocate by a stroke corresponding to the inclination angle of the swash plate. The rotary shaft receives a load acting toward the thrust bearing, the load being based on a pressure difference between the control pressure chamber and the swash plate chamber.

With this configuration, when the displacement increases so that the pressure in the control pressure chamber increases, the pressure difference between the control pressure chamber and the swash plate chamber increases. Accordingly, the load that is applied to the rotary shaft and acts toward the thrust bearing increases. This presses the rotary shaft against the thrust bearing, thereby fixing the position in the axial direction of the rotary shaft. Thus, even if an increase in the displacement increases the compression reaction force applied to the swash plate from the piston so that the thrust applied to the rotary shaft from the swash plate is increased, the rotary shaft is restrained from chattering due to the applied thrust since the position of the rotary shaft is fixed in the axial direction. In contrast, the compression reaction force applied to the swash plate from the piston is decreased when the displacement is decreased. Accordingly, the thrust transmitted to the rotary shaft from the swash plate is decreased. At this time, since the pressure in the control pressure chamber is lowered due to the decrease in the displacement, the pressure difference between the control pressure chamber and the swash plate chamber decreases. This reduces the load that is applied to the rotary shaft and acts toward the thrust bearing. Therefore, the sliding resistance between the thrust bearing and the rotary shaft is reduced, which reduces the power loss. From the above, it is possible to restrain chattering of the rotary shaft caused by the thrust acting on the rotary shaft, while reducing the power loss.

In the above described variable displacement swash plate type compressor, a spacer is preferably arranged between the cylinder block, which is arranged along the axis of the rotary shaft, and the rotary shaft. The spacer is supported by the rotary shaft while being restricted from rotating and allowed to move along the axis of the rotary shaft. The cylinder block and the spacer preferably define a pressure-acting chamber, which communicates with the control pressure chamber. A sealing member is preferably arranged between the spacer and the cylinder block. The sealing member seals off the pressure-acting chamber and the swash plate chamber from each other.

With this configuration, since the spacer is restricted from rotating with respect to the rotary shaft, the durability of the sealing member is improved as compared with a case where the spacer rotates integrally with the rotary shaft. Accordingly, the sealing performance between the pressure-acting chamber and the swash plate chamber is improved.

In the above described variable displacement swash plate type compressor, a spacer is preferably provided on the rotary shaft to be integrally rotational with the rotary shaft, and the cylinder block and the spacer preferably define a pressure-acting chamber, which communicates with the control pressure chamber. A sealing member is preferably arranged between the spacer and the cylinder block. The sealing member seals off the pressure-acting chamber and the swash plate chamber from each other.

With this configuration, since the spacer is allowed to rotate integrally with the rotary shaft, there is no need to provide a thrust bearing between the spacer and the rotary shaft, so that the number of components is reduced. This reduces the weight of the variable displacement swash plate type compressor.

In the above described variable displacement swash plate type compressor, the spacer preferably has a contact portion, which contacts the cylinder block and is located in a vicinity of the cylinder block that is located in the axial direction of the rotary shaft.

With this configuration, when the housing is assembled, the fastening force acting on the housing in the axial direction of the rotary shaft generates a load that acts toward the thrust bearing from the cylinder block via the contact portion. As a result, the rotary shaft is pressed against the thrust bearing, so that the position of the rotary shaft is determined in the axial direction. Therefore, for example, even when the operation of the variable displacement swash plate type compressor is stopped and the rotary shaft is not receiving the load based on the pressure difference between the control pressure chamber and the swash plate chamber, the positioning of the rotary shaft in the axial direction is ensured. Therefore, for example, even if the vehicle in which the variable displacement swash plate type compressor is installed vibrates and causes the compressor to vibrate, the rotary shaft is restrained from chattering in the axial direction.

In the above described variable displacement swash plate type compressor, the housing preferably includes a pair of cylinder blocks, and the pair of cylinder blocks preferably each have a cylinder bore. The cylinder bores form a pair. The pair of the cylinder bores reciprocally accommodates a double-headed piston, which is the piston. The double-headed piston defines a first compression chamber in one of the pair of the cylinder bores and a second compression chamber in the other one of the pair of the cylinder bores. A link mechanism is arranged between the rotary shaft and the swash plate. The link mechanism allows change of the inclination angle of the swash plate with respect to a direction that is perpendicular to the axis of the rotary shaft. The link mechanism is arranged such that, as the inclination angle of the swash plate is chanced, a top dead center position of the double-headed piston in the second compression chamber is displaced by a greater amount than a top dead center position of the double-headed piston in the first compression chamber. A direction of a compression reaction force acting on the swash plate from the double-headed piston in the first compression chamber is the same as a direction of the load applied to the rotary shaft based on the pressure difference between the control pressure chamber and the swash plate chamber.

When the dead volume of the second compression chamber is increased to a predetermined value due to reduction in the inclination angle of the swash plate, the double-headed piston no longer performs the discharge stroke in the second compression chamber. Then, the compression reaction force applied to the swash plate from the part of the double-headed piston in the first compression chamber exceeds the compression reaction force applied to the swash plate from the part of the double-headed piston in the second compression chamber. At this time, the direction of the compression reaction force acting on the swash plate from the part of the double-headed piston in the first compression chamber is the same as the direction of the load applied to the rotary shaft based on the pressure difference between the control pressure chamber and the swash plate chamber. This permits reduction in the load required to press the rotary shaft against the thrust bearing, that is, reduction in the load applied to the rotary shaft based on the pressure difference between the control pressure chamber and the swash plate chamber. This efficiently reduces chattering of the rotary shaft caused by the thrust acting on the rotary shaft.

In the above described variable displacement swash plate type compressor, an outer diameter of a head of the double-headed piston accommodated in one of the pair of the cylinder bores is preferably larger than an outer diameter of a head of the double-headed piston accommodated in the other cylinder bore of the pair.

With this configuration, the compression reaction force applied to the swash plate from the part of the double-headed piston in the first compression chamber is greater than in the case in which the outer diameter of a head of the double-headed piston accommodated in one of the pair of the cylinder bores is the same as or smaller than the outer diameter of the other head of the piston accommodated in the other cylinder bore. This further reduces the load required to press the rotary shaft against the thrust bearing, that is, the load applied to the rotary shaft based on the pressure difference between the control pressure chamber and the swash plate chamber. Thus, the chattering of the rotary shaft caused by the thrust acting on the rotary shaft is more efficiently reduced.

### Effects of the Invention

The present invention restrains chattering of the rotary shaft caused by the thrust acting on the rotary shaft, while reducing the power loss.

### BRIEF DESCRIPTION OF THE DRAWINGS

FIG. 1 is a cross-sectional side view illustrating a variable displacement swash plate type compressor according to one embodiment.

FIG. 2 is an enlarged partial cross-sectional view of the variable displacement swash plate type compressor, illustrating the spacer and the surrounding structure.

FIG. 3 is a diagram showing the relationship among the control pressure chamber, the pressure adjusting chamber, the suction chamber, and the discharge chamber.

FIG. 4 is a cross-sectional side view of the variable displacement swash plate type compressor when the swash plate is at the minimum inclination angle.

FIG. 5 is a partial cross-sectional view illustrating a variable displacement swash plate type compressor according to another embodiment.

FIG. 6 is a partial cross-sectional view illustrating a variable displacement swash plate type compressor according to another embodiment.

FIG. 7 is a cross-sectional side view illustrating a variable displacement swash plate type compressor according to another embodiment.

### MODES FOR CARRYING OUT THE INVENTION

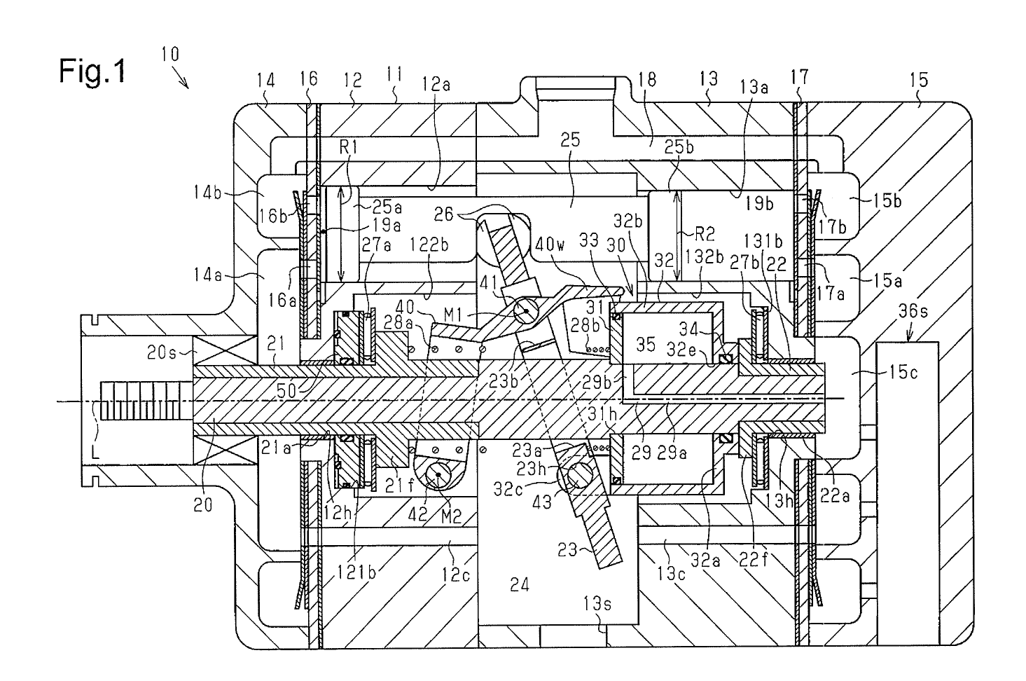

A variable displacement swash plate type compressor 10 according to one embodiment of the present invention will now be described with reference to FIGS. 1 to 4. In the following description, the variable displacement swash plate type compressor 10 will simply be referred to as a compressor 10. The compressor 10 is used in a vehicle air conditioner. The left side and the right side in FIG. 1 are defined as the front side and the rear side, respectively.

As shown in FIG. 1, the compressor 10 includes a housing 11, which has a pair of cylinder blocks, or a first cylinder block 12 and a second cylinder block 13, which are coupled to each other. The housing 11 further includes a front housing member 14 coupled to the first cylinder block 12 and a rear housing member 15 coupled to the second cylinder block 13. A first valve-port assembly plate 16 is arranged between the front housing member 14 and the first cylinder block 12. Further, a second valve-port assembly plate 17 is arranged between the rear housing member 15 and the second cylinder block 13.

A suction chamber 14a and a discharge chamber 14b are defined between the front housing member 14 and the first valve-port assembly plate 16. The discharge chamber 14b is located radially outward of the suction chamber 14a. A suction chamber 15a and a discharge chamber 15b are defined between the rear housing member 15 and the second valve-port assembly plate 17. A pressure adjusting chamber 15c is arranged in the rear housing member 15. The pressure adjusting chamber 15c is arranged at the center of the rear housing member 15. The suction chamber 15a is located radially outward of the pressure adjusting chamber 15c. The discharge chamber 15b is located radially outward of the suction chamber 15a. The discharge chambers 14b, 15b are connected to each other through a discharge passage 18. The discharge passage 18 is connected to an external refrigerant circuit (not shown). The discharge chambers 14b, 15b are discharge pressure zones.

The first valve-port assembly plate 16 has suction ports 16a, which communicate with the suction chamber 14a, and discharge ports 16b, which communicate with the discharge chamber 14b. The second valve-port assembly plate 17 has suction ports 17a, which communicate with the suction chamber 15a, and discharge ports 17b, which communicate with the discharge chamber 15b.

A rotary shaft 20, which has an axis L, is rotationally supported in the housing 11. A cylindrical first supporting member 21 is press fitted to the outer circumferential surface of the front end portion of the rotary shaft 20. A cylindrical second supporting member 22 is press fitted to the outer circumferential surface of the rear end portion of the rotary shaft 20. The first and second supporting members 21, 22 constitute parts of the rotary shaft 20. The first supporting member 21, which constitutes the front end portion of the rotary shaft 20, extends through a shaft hole 12h in the first cylinder block 12. The second supporting member 22, which constitutes the rear end portion of the rotary shaft 20, extends through a shaft hole 13h in the second cylinder block 13. The rear end portion of the second supporting member 22, that is, the rear end portion of the rotary shaft 20, is arranged in the pressure adjusting chamber 15c.

A first plain bearing 21a is arranged between the first supporting member 21 and the shaft hole 12h. A second plain bearing 22a is arranged between the second supporting member 22 and the shaft hole 13h. The first supporting member 21 is rotationally supported by the first cylinder block 12 via the first plain bearing 21a. The second supporting member 22 is rotationally supported by the second cylinder block 13 via the second plain bearing 22a.

A sealing device 20s of a lip seal type is located between the front housing member 14 and the rotary shaft 20. The front end of the rotary shaft 20 is coupled to an external drive source, which is a vehicle engine in this embodiment, through a power transmission mechanism (not shown). In the present embodiment, the power transmission mechanism is a clutchless mechanism formed by a combination of a belt and pulleys and constantly transmits power.

In the housing 11, the first cylinder block 12 and the second cylinder block 13 define a swash plate chamber 24. The swash plate chamber 24 accommodates a swash plate 23, which rotates when receiving drive force from the rotary shaft 20 and is tiltable along the axis of the rotary shaft 20. The swash plate 23 has a through-hole 23a, through which the rotary shaft 20 extends. The swash plate 23 is assembled to the rotary shaft 20 by inserting the rotary shaft 20 into the through-hole 23a.

The first cylinder block 12 has first cylinder bores 12a, which extend through the first cylinder block 12 along the axis and are arranged about the rotary shaft 20. FIG. 1 shows only one of the first cylinder bores 12a. Each first cylinder bore 12a is connected to the suction chamber 14a via the corresponding suction port 16a and is connected to the discharge chamber 14b via the corresponding discharge port 16b. The second cylinder block 13 has second cylinder bores 13a, which extend through the second cylinder block 13 along the axis and are arranged about the rotary shaft 20. FIG. 1 shows only one of the second cylinder bores 13a. Each second cylinder bore 13a is connected to the suction chamber 15a via the corresponding suction port 17a and is connected to the discharge chamber 15b via the corresponding discharge port 17b.

The inner diameter of the first cylinder bore 12a is larger than that of the second cylinder bore 13a. The first cylinder bores 12a and the second cylinder bores 13a are arranged to make front-rear pairs. Each pair of the first cylinder bore 12a and the second cylinder bore 13a accommodates a double-headed piston 25, while permitting the piston 25 to reciprocate in the front-rear direction. Specifically, each first cylinder bore 12a receives a first head 25a of the corresponding double-headed piston 25, and each second cylinder bore 13a receives a second head 25b of the corresponding double-headed piston 25. The outer diameter R1 of the first head 25a is larger than the outer diameter R2 of the second head 25b. The compressor 10 of the present embodiment is a double-headed piston swash plate type compressor.

Each double-headed piston 25 is engaged with the peripheral portion of the swash plate 23 with two shoes 26. When the swash plate 23 rotates together with the rotary shaft 20, the rotation of the swash plate 23 is converted into linear reciprocation of the double-headed pistons 25 by the shoes 26. Thus, the pairs of the shoes 26 function as a conversion mechanism that reciprocates the double-headed pistons 25 in the pairs of the first cylinder bores 12a and the second cylinder bores 13a as the swash plate 23 rotates. In each first cylinder bore 12a, a first compression chamber 19a is defined by the double-headed piston 25 and the first valve-port assembly plate 16. In each second cylinder bore 13a, a second compression chamber 19b is defined by the double-headed piston 25 and the second valve-port assembly plate 17.

The first cylinder block 12 has a first small diameter hole 121b, which is continuous with the shaft hole 12h and has a larger diameter than the shaft hole 12h. Further, the first cylinder block 12 has a first large diameter hole 122b, which is continuous with the first small diameter hole 121b and has a larger diameter than the first small diameter hole 121b. The first large diameter hole 122b communicates with the swash plate chamber 24 and constitutes a part of the swash plate chamber 24. The swash plate chamber 24 and the suction chamber 14a are connected to each other by a suction passage 12c, which extends through the first cylinder block 12 and the first valve-port assembly plate 16.

The second cylinder block 13 has a second small diameter hole 131b, which is continuous with the shaft hole 13h and has a larger diameter than the shaft hole 13h. Further, the second cylinder block 13 has a second large diameter hole 132b, which is continuous with the second small diameter hole 131b and has a larger diameter than the second small diameter hole 131b. The second large diameter hole 132b communicates with the swash plate chamber 24 and constitutes a part of the swash plate chamber 24. The swash plate chamber 24 and the suction chamber 15a are connected to each other by a suction passage 13c, which extends through the second cylinder block 13 and the second valve-port assembly plate 17.

An inlet 13s is provided in the peripheral wall of the second cylinder block 13. The inlet 13s is connected to the external refrigerant circuit. After being drawn into the swash plate chamber 24 from the external refrigerant circuit via the inlet 13s, refrigerant gas is drawn into the suction chambers 14a, 15a via the suction passages 12c, 13c. The suction chambers 14a, 15a and the swash plate chamber 24 are therefore suction pressure zones, and the pressures in the suction chambers 14a, 15a and the swash plate chamber 24 are substantially equal to each other.

An annular first flange 21f protrudes from the outer circumferential surface of the first supporting member 21. The first flange 21f is arranged in the first large diameter hole 122b. A first thrust bearing 27a and a spacer 50 are arranged between the first flange 21f and the first cylinder block 12. The first thrust bearing 27a and the spacer 50 are arranged such that the axes agree with the axis of the rotary shaft 20. The first thrust bearing 27a is closer to the first flange 21f than the spacer 50. An annular second flange 22f protrudes from the outer circumferential surface of the second supporting member 22. The second flange 22f is arranged in the second large diameter hole 132b. A second thrust bearing 27b is arranged between the second flange 22f and the second cylinder block 13. The second thrust bearing 27b is arranged such that the axis agrees with the axis of the rotary shaft 20. The second thrust bearing 27b is fitted in the second small diameter hole 131b. The first thrust bearing 27a and the second thrust bearing 27b bear the thrust that acts on the rotary shaft 20 in the axial direction.

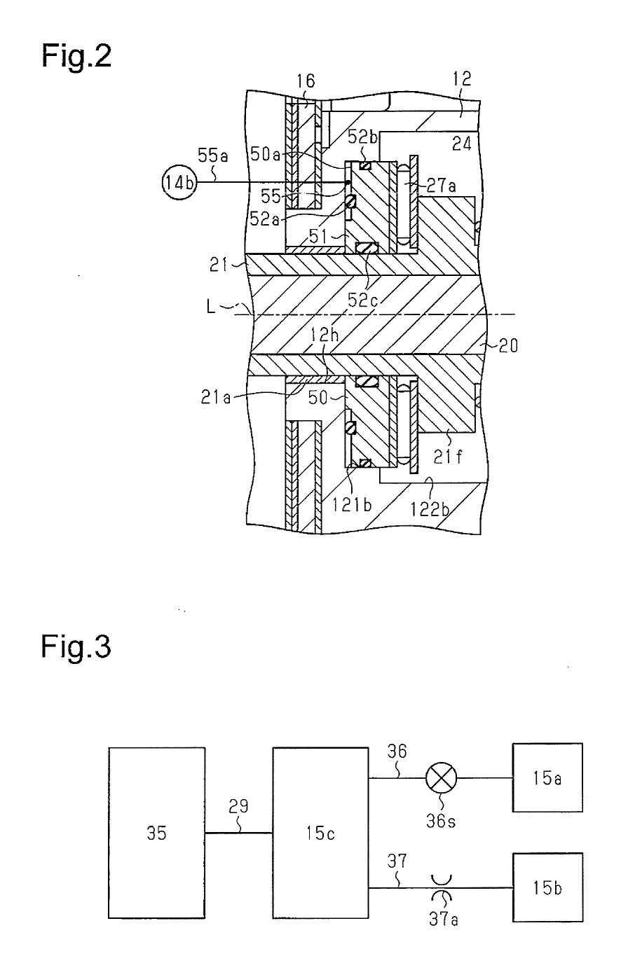

As shown in FIG. 2, the spacer 50 has an annular shape and is supported by the rotary shaft 20 while being restricted from rotating. The spacer 50 is fitted in the first small diameter hole 121b to be movable in the axial direction of the rotary shaft 20. An annular contact portion 51, which contacts the first cylinder block 12, protrudes from the spacer 50. The spacer 50 has two end faces arranged in the axial direction of the rotary shaft 20, and the contact portion 51 is provided on one of the end faces, or an end face 50a that is closer to the first cylinder block 12. The contact portion 51 is located in the vicinity of the inner edge of the spacer 50.

The spacer 50 is arranged in the first small diameter hole 121b with the contact portion 51 contacting the first cylinder block 12 and the end face 50a of the spacer 50 separated from the first cylinder block 12. An annular sealing member 52a is arranged in the end face 50a of the spacer 50 at a position radially outward of the contact portion 51. The sealing member 52a seals the gap between the end face 50a and the first cylinder block 12. A sealing member 52b is arranged on the outer circumferential surface of the spacer 50. The sealing member 52b seals the gap between the outer circumferential surface of the spacer 50 and the inner circumferential surface of the first small diameter hole 121b. Further, a sealing member 52c is arranged on the inner circumferential surface of the spacer 50. The sealing member 52c seals the gap between the inner circumferential surface of the spacer 50 and the outer circumferential surface of the first supporting member 21.

The first cylinder block 12 and the spacer 50 define a pressure-acting chamber 55. Specifically, the pressure-acting chamber 55 is a space defined by the first cylinder block 12, the spacer 50, and the sealing members 52a, 52b. The pressure-acting chamber 55 is connected to the discharge chamber 14b via a supply passage 55a. Thus, refrigerant gas is supplied to the pressure-acting chamber 55 from the discharge chamber 14b via the supply passage 55a. The sealing members 52a, 52b, 52c seal off the pressure-acting chamber 55 and the swash plate chamber 24 from each other. The sealing members 52a, 52b, 52c thus prevent the refrigerant gas supplied to the pressure-acting chamber 55 from leaking to the swash plate chamber 24.

As shown in FIG. 1, the swash plate chamber 24 accommodates an actuator 30, which is configured to change the inclination angle of the swash plate 23 with respect to a first direction, which is perpendicular to the axis L of the rotary shaft 20, that is, with respect to the vertical direction as viewed in FIG. 1. The actuator 30 is arranged between the second flange 22f and the swash plate 23. The actuator 30 includes an annular partition body 31, which is integrally rotational with the rotary shaft 20. The partition body 31 has a through-hole 31h, through which the rotary shaft 20 extends. The partition body 31 is integrated with the rotary shaft 20 by press fitting the rotary shaft 20 in the through-hole 31h.

The actuator 30 also has a cylindrical movable body 32, which has a closed end and is located between the second flange 22f and the partition body 31. The movable body 32 is movable along the axis of the rotary shaft 20 in the swash plate chamber 24. The movable body 32 is arranged to enter the second large diameter hole 132b. The movable body 32 includes an annular bottom portion 32a and a cylindrical portion 32b. The bottom portion 32a has a through-hole 32e, through which the rotary shaft 20 extends. The cylindrical portion 32b extends along the axis L of the rotary shaft 20 from the outer periphery of the bottom portion 32a. The movable body 32 is integrally rotational with the rotary shaft 20. The gap between the inner circumferential surface of the cylindrical portion 32b and the outer circumferential surface of the partition body 31 is sealed by a sealing member 33. The gap between the through-hole 32e and the rotary shaft 20 is sealed by a sealing member 34. The actuator 30 has a control pressure chamber 35 defined by the partition body 31 and the movable body 32.

A restoration spring 28a is fixed to the first supporting member 21. The restoration spring 28a extends from the first supporting member 21 toward the swash plate chamber 24. Also, a tilt reduction spring 28b is provided between the partition body 31 and the swash plate 23. The rear end of the tilt reduction spring 28b is fixed to the partition body 31. The front end of the tilt reduction spring 28b is fixed to the swash plate 23. The tilt reduction spring 28b urges the swash plate 23 in a direction for reducing the inclination angle of the swash plate 23.

The rotary shaft 20 has an in-shaft passage 29, which connects the control pressure chamber 35 and the pressure adjusting chamber 15c to each other. The in-shaft passage 29 is constituted by a first in-shaft passage 29a, which extends along the axis L of the rotary shaft 20, and a second in-shaft passage 29b, which communicates with the first in-shaft passage 29a and extends in a radial direction of the rotary shaft 20. The rear end of the first in-shaft passage 29a communicates with the pressure adjusting chamber 15c. The lower end of the second in-shaft passage 29b communicates with the front end of the first in-shaft passage 29a. The upper end of the second in-shaft passage 29b opens to the interior of the control pressure chamber 35. Thus, the control pressure chamber 35 and the pressure adjusting chamber 15c are connected to each other by the first in-shaft passage 29a and the second in-shaft passage 29b.

As shown in FIG. 3, the pressure adjusting chamber 15c and the suction chamber 15a are connected to each other by a bleed passage 36. An electromagnetic control valve 36s, which functions as a control mechanism, is arranged in the bleed passage 36. The control valve 36s is capable of adjusting the opening degree of the bleed passage 36 based on the pressure in the suction chamber 15a. The control valve 36s adjusts the flow rate of the refrigerant flowing through the bleed passage 36 to control the pressure in the pressure adjusting chamber 15c. The pressure adjusting chamber 15c and the discharge chamber 15b are connected to each other by a supply passage 37. The supply passage 37 has an orifice 37a. The orifice 37a limits the flow rate of the refrigerant gas flowing through the supply passage 37.

Refrigerant gas is introduced to the control pressure chamber 35 from the discharge chamber 15b via the supply passage 37, the pressure adjusting chamber 15c, the first in-shaft passage 29a, and the second in-shaft passage 29b. Also, refrigerant gas is discharged from the control pressure chamber 35 to the suction chamber 15a via the second in-shaft passage 29b, the first in-shaft passage 29a, the pressure adjusting chamber 15c, and the bleed passage 36. Accordingly, the pressure in the control pressure chamber 35 is controlled. The pressure difference between the control pressure chamber 35 and the swash plate chamber 24 causes the movable body 32 to move along the axis L of the rotary shaft 20 with respect to the partition body 31. The refrigerant gas introduced into the control pressure chamber 35 serves as control gas for controlling the movement of the movable body 32.

Referring to FIG. 1, in the swash plate chamber 24, a lug arm 40 is provided between the swash plate 23 and the first flange 21f. The lug arm 40 serves as a link mechanism that allows change of the inclination angle of the swash plate 23. The lug arm 40 substantially has an L shape as a whole. A weight portion 40w is provided in the rear part of the lug arm 40. The weight portion 40w is passed through a groove 23b of the swash plate 23 to be located at a position behind the swash plate 23.

The rear part of the lug arm 40 is coupled to the upper end of the swash plate 23 by a first pin 41, which extends across the groove 23b. The rear part of the lug arm 40 is thus supported by the swash plate 23 to be pivotal about a first pivot axis M1, which is the axis of the first pin 41. The front part of the lug arm 40 is coupled to a coupling portion (not shown) of the first supporting member 21 by a columnar second pin 42. The front part of the lug arm 40 is thus supported by the first supporting member 21 to be pivotal about a second pivot axis M2, which is the axis of the second pin 42.

A coupling portion 32c is provided at the distal end of the cylindrical portion 32b of the movable body 32. The coupling portion 32c protrudes toward the swash plate 23. A columnar coupling pin 43 is fixed to the coupling portion 32c. The swash plate 23 has a through-hole 23h, through which the coupling pin 43 extends. The through-hole 23h is located in a part of the swash plate 23 that is radially outward of the through-hole 23a. That is, the coupling pin 43 couples the coupling portion 32c to the lower end of the swash plate 23.

Increase in the opening degree of the control valve 36s increases the flow rate of refrigerant gas that is discharged from the control pressure chamber 35 to the suction chamber 15a via the second in-shaft passage 29b, the first in-shaft passage 29a, the pressure adjusting chamber 15c, and the bleed passage 36. This substantially equalizes the pressure in the pressure adjusting chamber 15c with the pressure in the suction chamber 15a and substantially equalizes the pressure in the control pressure chamber 35 with the pressure in the suction chamber 15a. This reduces the pressure difference between the control pressure chamber 35 and the swash plate chamber 24. Thus, the compression reactive force acting on the swash plate 23 from the double-headed pistons 25 causes the swash plate 23 to pull the movable body 32 via the coupling pin 43. As a result, the bottom portion 32a of the movable body 32 approaches the partition body 31.

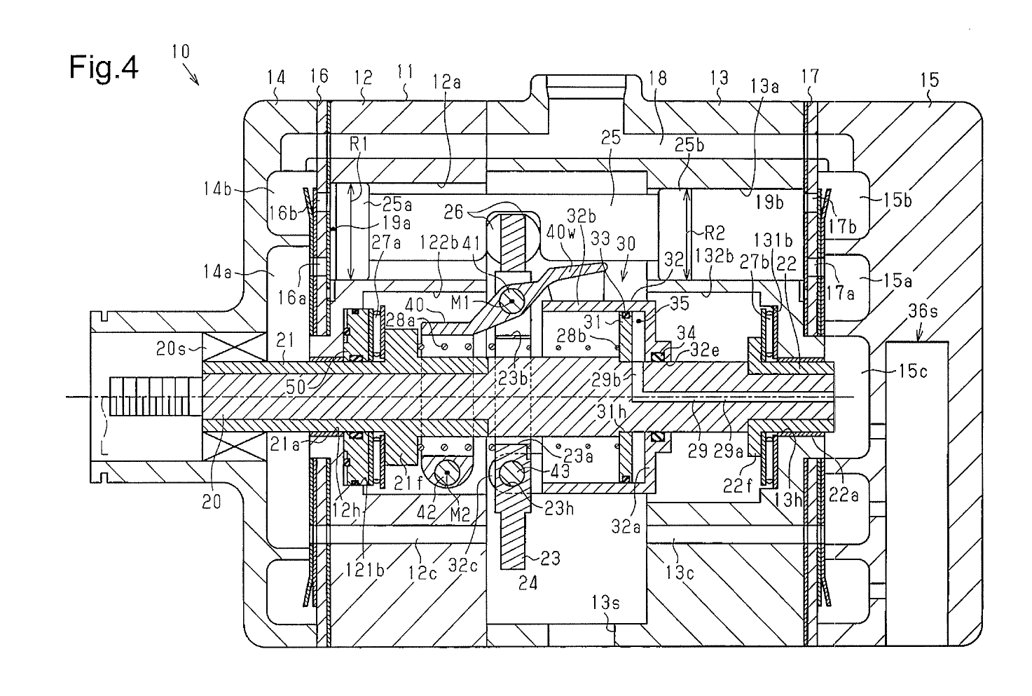

When the bottom portion 32a of the movable body 32 approaches the partition body 31 as shown in FIG. 4, the swash plate 23 pivots about the first pivot axis M1 and the lug arm 40 pivots about the second pivot axis M2, so that the lug arm 40 approaches the first flange 21f. Accordingly, the inclination angle of the swash plate 23 is reduced so that the swash plate 23 contacts the restoration spring 28a. When the inclination angle of the swash plate 23 is reduced, the stroke of the double-headed pistons 25 is reduced. Accordingly, the displacement is decreased.

In the compressor 10 of the present embodiment, each pair of the first cylinder bore 12a and the second cylinder bore 13a reciprocally accommodates a double-headed piston 25. In this configuration, as the inclination angle of the swash plate 23 decreases, the dead volume of the second compression chamber 19b, that is, the gap between the double-headed piston 25 at the top dead center and the second valve-port assembly plate 17 is increased. In contrast, the discharge stroke is executed without significantly increasing the dead volume of the first compression chamber 19a, that is, the gap between the double-headed piston 25 at the top dead center and the first valve-port assembly plate 16. Thus, the lug arm 40 is arranged such that, as the inclination angle of the swash plate 23 is changed, the top dead center position of the double-headed piston 25 in each second compression chamber 19b is displaced by a greater amount than the top dead center position of the piston 25 in the corresponding first compression chamber 19a.

Thus, when the dead volume of the second compression chamber 19b becomes a predetermined volume as the inclination angle of the swash plate 23 is reduced to a predetermined inclination angle, refrigerant gas stops being discharged from the second compression chamber 19b. Therefore, as the inclination angle of the swash plate 23 is reduced from the predetermined angle to the minimum inclination, the pressure in the second compression chamber 19b stops reaching the discharge pressure. This stops discharge and suction of refrigerant gas, and only compression and expansion of refrigerant gas are repeated.

Decrease in the opening degree of the control valve 36s decreases the flow rate of refrigerant gas that is discharged from the control pressure chamber 35 to the suction chamber 15a via the second in-shaft passage 29b, the first in-shaft passage 29a, the pressure adjusting chamber 15c, and the bleed passage 36. Since refrigerant gas is supplied to the control pressure chamber 35 from the discharge chamber 15b via the supply passage 37, the pressure adjusting chamber 15c, the first in-shaft passage 29a, and the second in-shaft passage 29b, the pressure in the control pressure chamber 35 is substantially equalized with the pressure in the discharge chamber 15b. This increases the pressure difference between the control pressure chamber 35 and the swash plate chamber 24. Thus, the movable body 32 pulls the swash plate 23 via the coupling pin 43. As a result, the bottom portion 32a of the movable body 32 is moved away from the partition body 31.

When the bottom portion 32a of the movable body 32 is moved away from the partition body 31 as shown in FIG. 1, the swash plate 23 is pivoted about the first pivot axis M1 in a direction opposite to the pivoting direction for decreasing the inclination angle of the swash plate 23. Also, the lug arm 40 pivots about the second pivot axis M2 in a direction opposite to the pivoting direction for decreasing the inclination angle of the swash plate 23. The lug arm 40 thus moves away from the first flange 21f. This increases the inclination angle of the swash plate 23 and thus increases the stroke of the double-headed pistons 25. Accordingly, the displacement is increased.

Operation of the present embodiment will now be described.

When the displacement is increased and the pressure in the discharge chamber 14b is raised, the pressure difference between the pressure-acting chamber 55 and the swash plate chamber 24 increases. This moves the spacer 50 toward the first thrust bearing 27a. Accordingly, the spacer 50 pushes the first thrust bearing 27a, so that the first thrust bearing 27a is pressed against the first flange 21f by the spacer 50. As a result, the first thrust bearing 27a is tightly held between the spacer 50 and the first flange 21f. When the first thrust bearing 27a is pressed against the first flange 21f, the rotary shaft 20 is pushed toward the second thrust bearing 27b. As a result, the second flange 22f is pressed against the second thrust bearing 27b, so that the second thrust bearing 27b is tightly held between the second flange 22f and the second cylinder block 13. The rotary shaft 20 thus receives a load that is generated based on the pressure difference between the pressure-acting chamber 55 and the swash plate chamber 24 and acts toward the second thrust bearing 27b.

The rotary shaft 20 is tightly held by the first thrust bearing 27a and the second thrust bearing 27b with respect to the axial direction. This determines the position of the rotary shaft 20 in the axial direction. Thus, when the displacement increases so that the compression reaction force applied to the swash plate 23 from the double-headed pistons 25 is increased, the thrust applied to the rotary shaft 20 from the swash plate 23 is increased. Even in such a case, since the position of the rotary shaft 20 is determined in the axial direction, the rotary shaft 20 is restrained from chattering due to the thrust acting on the rotary shaft 20.

In contrast, when the displacement decreases, the compression reaction force applied to the swash plate 23 from the double-headed pistons 25 is decreased, and the thrust transmitted to the rotary shaft 20 from the swash plate 23 is decreased, accordingly. At this time, since the pressure in the discharge chamber 14b is lowered due to the decrease in the displacement, the pressure difference between the discharge chamber 14b and the swash plate chamber 24 decreases. This reduces the force with which the spacer 50 presses the first thrust bearing 27a against the first flange 21f. As a result, the force with which the second flange 22f is pressed against the second thrust bearing 27b is reduced. Thus, the load applied to the rotary shaft 20 toward the second thrust bearing 27b is reduced. Therefore, the sliding resistance between the first thrust bearing 27a and the rotary shaft 20 and the sliding resistance between the second thrust bearing 27b and the rotary shaft 20 are both reduced, which reduces the power loss.

When the inclination angle of the swash plate 23 is reduced, the dead volume of each second compression chamber 19b is increased. When the dead volume of each second compression chamber 19b reaches a predetermined value, the double-headed pistons 25 no longer perform the discharge stroke in the second compression chambers 19b. Then, the compression reaction force applied to the swash plate 23 from the parts of the double-headed pistons 25 in the first compression chambers 19a exceeds the compression reaction force applied to the swash plate 23 from the parts of the double-headed pistons 25 in the second compression chambers 19b. At this time, the direction of the compression reaction force acting on the swash plate 23 from the parts of the double-headed pistons 25 in the first compression chambers 19a is the same as the direction of the load applied to the rotary shaft 20 based on the pressure difference between the pressure-acting chamber 55 and the swash plate chamber 24. This permits reduction in the load required to press the rotary shaft 20 against the second thrust bearing 27b, that is, reduction in the load applied to the rotary shaft 20 based on the pressure difference between the pressure-acting chamber 55 and the swash plate chamber 24.

The above described embodiment provides the following advantages.

(1) The rotary shaft 20 receives a load that is generated based on the pressure difference between the pressure-acting chamber 55 and the swash plate chamber 24 and acts toward the second thrust bearing 27b. In this configuration, when the displacement is increased and the pressure in the discharge chamber 14b is raised, the pressure difference between the pressure-acting chamber 55 and the swash plate chamber 24 increases. In this case, the load that is applied to the rotary shaft 20 and acts toward the second thrust bearing 27b is increased. This presses the rotary shaft 20 against the second thrust bearing 27b, thereby fixing the position in the axial direction of the rotary shaft 20. Thus, when the displacement increases so that the compression reaction force applied to the swash plate 23 from the double-headed pistons 25 is increased, the thrust applied to the rotary shaft 20 from the swash plate 23 is increased. Even in such a case, since the position of the rotary shaft 20 is fixed in the axial direction, the rotary shaft 20 is restrained from chattering due to the thrust acting on the rotary shaft 20.

In contrast, when the displacement decreases, the compression reaction force applied to the swash plate 23 from the double-headed pistons 25 is decreased, and the thrust transmitted to the rotary shaft 20 from the swash plate 23 is decreased, accordingly. At this time, since the pressure in the pressure-acting chamber 55 is lowered due to the decrease in the displacement, the pressure difference between the pressure-acting chamber 55 and the swash plate chamber 24 decreases. Thus, the load applied to the rotary shaft 20 toward the second thrust bearing 27b is reduced. This reduces the sliding resistance between the second thrust bearing 27b and the rotary shaft 20 and thus reduces the power loss. In this manner, it is possible to restrain the rotary shaft 20 from chattering due to the thrust acting on the rotary shaft 20 while reducing the power loss.

(2) The spacer 50 is supported by the rotary shaft 20 while being restricted from rotating and allowed to move in the axial direction of the rotary shaft 20. Compared to a configuration in which the spacer 50 rotates integrally with the rotary shaft 20, the durability of the sealing members 52a, 52b is improved so that the pressure-acting chamber 55 and the swash plate chamber 24 are sealed off from each other in a reliable manner.

(3) The contact portion 51 of the spacer 50 contacts the first cylinder block 12. In this configuration, the fastening force acting on the housing 11 in the axial direction of the rotary shaft 20, which is generated when the first cylinder block 12, the second cylinder block 13, the front housing member 14, and the rear housing member 15 are assembled, generates a load. The load acts toward the second thrust bearing 27b and is applied to the spacer 50 from the first cylinder block 12 via the contact portion 51. As a result, since the rotary shaft 20 is pressed against the second thrust bearing 27b, the position of the rotary shaft 20 is determined in the axial direction. Thus, for example, when the compressor 10 is stopped and the rotary shaft 20 receives no load based on the pressure difference between the pressure-acting chamber 55 and the swash plate chamber 24, the position of the rotary shaft 20 in the axial direction is fixed. Therefore, for example, even if the vehicle in which the compressor 10 is installed vibrates and causes the compressor 10 to vibrate, the rotary shaft 20 is restrained from chattering in the axial direction.

(4) When the dead volume of each second compression chamber 19b is increased to a predetermined value due to reduction in the inclination angle of the swash plate 23, the double-headed pistons 25 no longer perform the discharge stroke in the second compression chambers 19b. Then, the compression reaction force applied to the swash plate 23 from the parts of the double-headed pistons 25 in the first compression chambers 19a exceeds the compression reaction force applied to the swash plate 23 from the parts of the double-headed pistons 25 in the second compression chambers 19b. At this time, the direction of the compression reaction force acting on the swash plate 23 from the parts of the double-headed pistons 25 in the first compression chambers 19a is the same as the direction of the load applied to the rotary shaft 20 based on the pressure difference between the pressure-acting chamber 55 and the swash plate chamber 24. This permits reduction in the load required to press the rotary shaft 20 against the second thrust bearing 27b, that is, reduction in the load applied to the rotary shaft 20 based on the pressure difference between the pressure-acting chamber 55 and the swash plate chamber 24. This efficiently reduces chattering of the rotary shaft 20 caused by the thrust acting on the rotary shaft 20.

(5) The outer diameter R1 of the first head 25a is larger than the outer diameter R2 of the second head 25b. In this configuration, the compression reaction force applied to the swash plate 23 by the parts of the double-headed pistons 25 in the first compression chambers 19a is greater than that in the case in which the outer diameter R1 of the first head 25a is equal to the outer diameter R2 of the second head 25b or that in the case in which the outer diameter R1 of the first head 25a is smaller than the outer diameter R2 of the second head 25b. This permits further reduction in the load required to press the rotary shaft 20 against the second thrust bearing 27b, that is, reduction in the load applied to the rotary shaft 20 based on the pressure difference between the pressure-acting chamber 55 and the swash plate chamber 24. This further efficiently reduces chattering of the rotary shaft 20 caused by the thrust acting on the rotary shaft 20.

(6) It is now assumed that the direction of the compression reaction force acting on the swash plate 23 from the parts of the double-headed pistons 25 in the first compression chambers 19a is opposite to the direction of the load applied to the rotary shaft 20 based on the pressure difference between the pressure-acting chamber 55 and the swash plate chamber 24. In this case, to press the rotary shaft 20 against the second thrust bearing 27b using the load based on the pressure difference between the pressure-acting chamber 55 and the swash plate chamber 24, that load needs to be greater than the compression reaction force applied to the swash plate 23 from the parts of the pistons 25 in the first compression chambers 19a. Accordingly, the pressure receiving area of the pressure-acting chamber 55 needs to be increased. In the present embodiment, the direction of the compression reaction force acting on the swash plate 23 from the parts of the double-headed pistons 25 in the first compression chambers 19a is the same as the direction of the load applied to the rotary shaft 20 based on the pressure difference between the pressure-acting chamber 55 and the swash plate chamber 24. This reduces the pressure receiving area of the pressure-acting chamber 55. This allows the size of the spacer 50 and thus the size of the compressor 10 to be reduced.

The above described embodiment may be modified as follows.

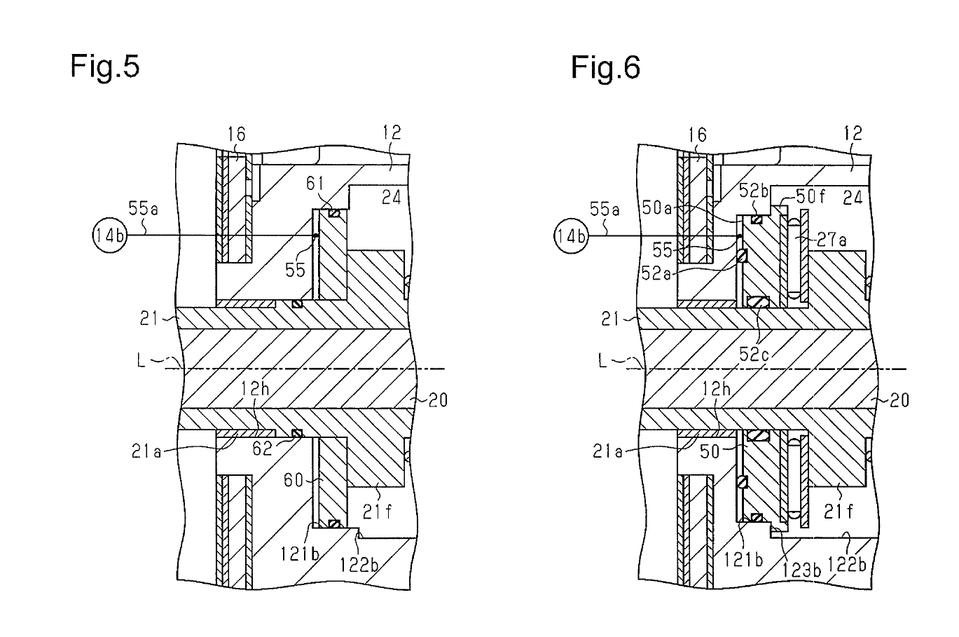

As shown in FIG. 5, a spacer 60 that is rotational integrally with the rotary shaft 20 may be employed. The spacer 60 has an annular shape and is press-fitted and fixed to the rotary shaft 20. A sealing member 61 is arranged in the outer circumferential surface of the spacer 60 to seal the gap between the outer circumferential surface of the spacer 60 and the inner circumferential surface of the first small diameter hole 121b. The spacer 60 is arranged in the first small diameter hole 121b with the end face closer to the first cylinder block 12 separated from the first cylinder block 12. Also, the first cylinder block 12 and the spacer 50 define a pressure-acting chamber 55. A sealing member 62 is arranged in the outer circumferential surface of the first supporting member 21 to seal the gap between the shaft hole 12h and the outer circumferential surface of the first supporting member 21. In this configuration, since the spacer 60 is rotational integrally with the rotary shaft 20, no thrust bearing needs to be arranged between the spacer 60 and the rotary shaft 20. This reduces the number of components and thus the weight of the compressor 10.

The spacer 60 shown in FIG. 5 may be integrated with the rotary shaft 20.

As shown in FIG. 6, the contact portion 51 may be omitted from the spacer 50. In this case, the spacer 50 has a flange 50f on the outer circumferential surface at a position in the vicinity of the first large diameter hole 122b. The flange 50f contacts an end face 123b of the boundary between the first small diameter hole 121b and the first large diameter hole 122b in the first cylinder block 12. In this configuration, the spacer 50 is allowed to be arranged in the first small diameter hole 121b by bringing the flange 50f into contact with the end face 123b with the end face 50a separated from the first cylinder block 12.

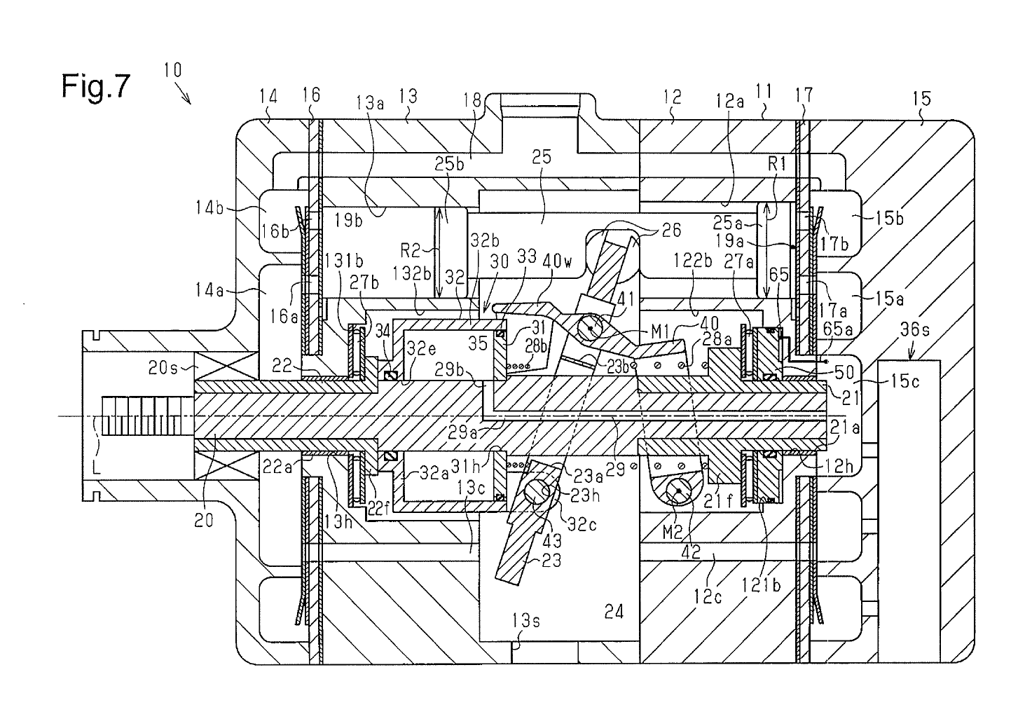

As shown in FIG. 7, a pressure-acting chamber 65 may communicate with the control pressure chamber 35, and the pressure in the pressure-acting chamber 65 may equal to the pressure in the control pressure chamber 35. Also, the rotary shaft 20 may receive a load that is generated based on the pressure difference between the control pressure chamber 35 and the swash plate chamber 24 and acts toward the second thrust bearing 27b. In the embodiment shown in FIG. 7, the first cylinder block 12, the second cylinder block 13, the swash plate 23, the double-headed pistons 25, the first thrust bearing 27a, the second thrust bearing 27b, the actuator 30, the lug arm 40, the spacer 50, and the like are arranged at reversed positions in relation to the positions shown in FIGS. 1 to 4 in the axial direction of the rotary shaft 20. In the embodiment shown in FIG. 7, the sealing member 52a, which is used in the embodiment shown in FIGS. 1 to 4, may be omitted. The first cylinder block 12 has a supply passage 65a, which connects the pressure-acting chamber 65 and the pressure adjusting chamber 15c. Refrigerant gas is supplied to the pressure-acting chamber 65 from the pressure adjusting chamber 15c via the supply passage 65a. The pressure in the pressure adjusting chamber 15c is equal to the pressure in the control pressure chamber 35. The direction of the compression reaction force acting on the swash plate 23 from the parts of the double-headed pistons 25 in the first compression chambers 19a is the same as the direction of the load applied to the rotary shaft 20 based on the pressure difference between the pressure-acting chamber 65 and the swash plate chamber 24.

When the displacement is increased and the pressure in the control pressure chamber 35 is raised, the pressure difference between the pressure-acting chamber 65 and the swash plate chamber 24 increases. This moves the spacer 50 toward the first thrust bearing 27a. Accordingly, the spacer 50 pushes the first thrust bearing 27a, so that the first thrust bearing 27a is pressed against the first flange 21f by the spacer 50. As a result, the first thrust bearing 27a is tightly held between the spacer 50 and the first flange 21f. When the first thrust bearing 27a is pressed against the first flange 21f, the rotary shaft 20 is pushed toward the second thrust bearing 27b. As a result, the second flange 22f is pressed against the second thrust bearing 27b, so that the second thrust bearing 27b is tightly held between the second flange 22f and the second cylinder block 13. The rotary shaft 20 thus receives a load that is generated based on the pressure difference between the pressure-acting chamber 65 and the swash plate chamber 24 and acts toward the second thrust bearing 27b.

In this way, the rotary shaft 20 is tightly held by the first thrust bearing 27a and the second thrust bearing 27b with respect to the axial direction of the rotary shaft 20. This determines the position of the rotary shaft 20 in the axial direction. Thus, when the displacement increases so that the compression reaction force applied to the swash plate 23 from the double-headed pistons 25 is increased, the thrust applied to the rotary shaft 20 from the swash plate 23 is increased. Even in such a case, since the position of the rotary shaft 20 is determined in the axial direction, the rotary shaft 20 is restrained from chattering due to the thrust acting on the rotary shaft 20.

In contrast, the compression reaction force applied to the swash plate 23 from the double-headed pistons 25 is decreased when the displacement is decreased. Accordingly, the thrust transmitted to the rotary shaft 20 from the swash plate 23 is decreased. At this time, since the pressure in the control pressure chamber 35 is lowered due to the decrease in the displacement, the pressure difference between the pressure-acting chamber 65 and the swash plate chamber 24 decreases. This reduces the force with which the spacer 50 presses the first thrust bearing 27a against the first flange 21f. As a result, the force with which the second flange 22f is pressed against the second thrust bearing 27b is also reduced. Thus, the load applied to the rotary shaft 20 toward the second thrust bearing 27b is reduced. As a result, the sliding resistance between the first thrust bearing 27a and the rotary shaft 20 and the sliding resistance between the second thrust bearing 27b and the rotary shaft 20 are both reduced, which reduces the power loss.

As the displacement increases, the pressure in the control pressure chamber 35 approaches the pressure in the discharge chamber 15b. As the displacement decreases, the pressure in the control pressure chamber 35 approaches the pressure in the suction chamber 15a. When the displacement increases, the load based on the pressure difference between the pressure-acting chamber 65 and the swash plate chamber 24 approaches the load based on the pressure difference between the discharge chamber 15b and the swash plate chamber 24. Thus, the thrust transmitted from the swash plate 23 to the rotary shaft 20 is increased when the displacement increases so that the compression reaction force acting on the swash plate 23 from the double-headed pistons 25 increases. In this case, the rotary shaft 20 receives a load that acts toward the second thrust bearing 27b. The received load is equivalent to the load that is generated based on the pressure difference between the discharge chamber 15b and the swash plate chamber 24. As described above, when the displacement increases so that the compression reaction force applied to the swash plate 23 from the double-headed pistons 25 is increased, the thrust applied to the rotary shaft 20 from the swash plate 23 is increased. Even in this case, the position of the rotary shaft 20 is fixed in the axial direction. The rotary shaft 20 is thus restrained from chattering due to the thrust acting on the rotary shaft 20.

In contrast, when the displacement decreases, the load based on the pressure difference between the pressure-acting chamber 65 and the swash plate chamber 24 approaches the load based on the pressure difference between the suction chamber 15a and the swash plate chamber 24. Thus, as the displacement decreases, the load applied to the rotary shaft 20 toward the second thrust bearing 27b decreases to approach the load based on the pressure difference between the suction chamber 15a and the swash plate chamber 24. Therefore, when the displacement is changed, the load applied to the rotary shaft 20 toward the second thrust bearing 27b becomes smaller than the load based on the pressure difference between the discharge chamber 15b and the swash plate chamber 24. This reduces the sliding resistance between the second thrust bearing 27b and the rotary shaft 20 and thus reduces the power loss.

The embodiment illustrated in FIG. 7 is basically the same as the embodiment shown in FIGS. 1 to 4 except that the load based on the pressure difference between the pressure in the control pressure chamber 35 and the swash plate chamber 24 is applied to the rotary shaft 20 toward the second thrust bearing 27b. Therefore, the embodiment shown in FIG. 7 achieves the same advantages as the advantages (2) to (6) of the embodiment shown in FIGS. 1 to 4.

A spacer that is rotational integrally with the rotary shaft 20 as illustrated in FIG. 5 may be employed in the embodiment illustrated in FIG. 7, in which the load based on the pressure difference between the pressure in the control pressure chamber 35 and the swash plate chamber 24 is applied to the rotary shaft 20 toward the second thrust bearing 27b. With this configuration, since the spacer is allowed to rotate integrally with the rotary shaft 20, there is no need to provide a thrust bearing between the spacer and the rotary shaft 20, so that the number of components is reduced.

The direction in which the compression reaction force acts on the swash plate 23 from the double-headed pistons 25 in the first compression chambers 19a may be opposite to the direction of the load applied to the rotary shaft 20 based on the pressure difference between the pressure-acting chamber 55 and the swash plate chamber 24.

The outer diameter R1 of the first head 25a may be equal to the outer diameter R2 of the second head 25b.

The outer diameter R1 of the first head 25a is smaller than the outer diameter R2 of the second head 25b.

The discharge chamber 15b may communicate with the pressure-acting chamber 55.

The actuator 30 may be modified to operate such that, when the pressure in the control pressure chamber 35 is substantially equal to the pressure in the suction chamber 15a, the movable body 32 is moved to increase the inclination angle of the swash plate 23, and that, when the pressure in the control pressure chamber 35 is substantially equal to the pressure in the discharge chamber 15b, the movable body 32 is moved to reduce the inclination angle of the swash plate 23. That is, the actuator 30 may be configured to increase the displacement by lowering the pressure in the control pressure chamber 35.

An electromagnetic control valve may be provided on the supply passage 37, which connects the pressure adjusting chamber 15c and the discharge chamber 15b to each other, and an orifice may be provided in the bleed passage, which connects the pressure adjusting chamber 15c and the suction chamber 15a to each other.

The compressor 10 may be a single-headed piston swash plate type compressor, which has single-headed pistons.

The compressor 10 may obtain the drive force from an external drive source via a clutch.

### DESCRIPTION OF THE REFERENCE NUMERALS

10 . . . Variable Displacement Swash Plate Type Compressor; 11 . . . Housing; 12 . . . First Cylinder Block as Cylinder Block; 12a . . . First Cylinder Bore as Cylinder Bore; 13 . . . Second Cylinder Block as Cylinder Block; 13a . . . Second Cylinder Bore as Cylinder Bore; 14b, 15b . . . Discharge Chambers; 19a . . . First Compression Chamber as One Compression Chamber; 19b . . . Second Compression Chamber as The Other Compression Chamber; 20 . . . Rotary Shaft; 23 . . . Swash Plate; 24 . . . Swash Plate Chamber; 25 . . . Double-Headed Piston as Piston; 25a . . . First Head as One Head; 25b . . . Second Head as The Other Head; 27b . . . Second Thrust Bearing as Thrust Bearing; 30 . . . Actuator; 31 . . . Partition Body; 32 . . . Movable Body; 35 . . . Control Pressure Chamber; 40 . . . Lug Arm as Link Mechanism; 50, 60 . . . Spacers; 51 . . . Contact Portion; 52a, 52b, 52c . . . Sealing Members; 55, 65 . . . Pressure-acting chambers

1.-12. (canceled)

13. A variable displacement swash plate type compressor comprising:
a housing including a discharge chamber and a pair of cylinder blocks, wherein the pair of cylinder blocks each have a cylinder bore, the cylinder bores forming a pair;
a rotary shaft rotationally supported by the housing;
a thrust bearing arranged between the cylinder block, which is arranged along an axis of the rotary shaft, and the rotary shaft, wherein the thrust bearing bears a thrust that acts in an axial direction of the rotary shaft;
a swash plate chamber, which is provided in the housing and draws in refrigerant from outside;
a swash plate accommodated in the swash plate chamber, wherein the swash plate is rotated by receiving a drive force from the rotary shaft and is tiltable relative to a direction perpendicular to the axis of the rotary shaft;
a double-headed piston reciprocally accommodated in the pair of the cylinder bores,
an actuator, which is arranged in the swash plate chamber and configured to change an inclination angle of the swash plate, wherein
the actuator includes
a partition body provided on the rotary shaft,
a movable body, which is provided in the swash plate chamber and movable along the axis of the rotary shaft, and
a control pressure chamber, which is defined by the partition body and the movable body, wherein the movable body is moved by a pressure in the control pressure chamber,
as the movable body moves along the axis of the rotary shaft, the inclination angle of the swash plate is changed so that the piston reciprocates by a stroke in accordance with the inclination angle of the swash plate,
the rotary shaft receives a load acting toward the thrust bearing, the load being based on a pressure difference between the discharge chamber and the swash plate chamber,
the double-headed piston defines a first compression chamber in one of the pair of the cylinder bores and a second compression chamber in the other one of the pair of the cylinder bores,
a link mechanism is arranged between the rotary shaft and the swash plate, wherein the link mechanism allows change of the inclination angle of the swash plate with respect to a direction that is perpendicular to the axis of the rotary shaft,
the link mechanism is arranged such that, as the inclination angle of the swash plate is changed, a top dead center position of the double-headed piston in the second compression chamber is displaced by a greater amount than a top dead center position of the double-headed piston in the first compression chamber, and
a direction of a compression reaction force acting on the swash plate from the double-headed piston in the first compression chamber is the same as a direction of the load applied to the rotary shaft based on the pressure difference between the discharge chamber and the swash plate chamber.

14. The variable displacement swash plate type compressor according to claim 13, wherein
a spacer is arranged between the cylinder block, which is arranged along the axis of the rotary shaft, and the rotary shaft, wherein the spacer is supported by the rotary shaft while being restricted from rotating and allowed to move along the axis of the rotary shaft,
the cylinder block and the spacer define a pressure-acting chamber, which communicates with the discharge chamber, and
a sealing member is arranged between the spacer and the cylinder block, wherein the sealing member seals off the pressure-acting chamber and the swash plate chamber from each other.

15. The variable displacement swash plate type compressor according to claim 13, wherein
a spacer is provided on the rotary shaft to be integrally rotational with the rotary shaft,
the cylinder block and the spacer define a pressure-acting chamber, which communicates with the discharge chamber, and
a sealing member is arranged between the spacer and the cylinder block, wherein the sealing member seals off the pressure-acting chamber and the swash plate chamber from each other.

16. The variable displacement swash plate type compressor according to claim 14, wherein the spacer has a contact portion, which contacts the cylinder block and is located in a vicinity of the cylinder block that is located in the axial direction of the rotary shaft.

17. The variable displacement swash plate type compressor according to claim 13, wherein an outer diameter of a head of the double-headed piston accommodated in one of the pair of the cylinder bores is larger than an outer diameter of a head of the double-headed piston accommodated in the other cylinder bore of the pair.

18. A variable displacement swash plate type compressor comprising:
a housing having a cylinder block, in which a discharge chamber and a plurality of cylinder bores are provided;
a rotary shaft rotationally supported by the housing;
a thrust bearing arranged between the cylinder block, which is arranged along an axis of the rotary shaft, and the rotary shaft, wherein the thrust bearing bears a thrust that acts in an axial direction of the rotary shaft;
a swash plate chamber, which is provided in the housing and draws in refrigerant from outside;
a swash plate accommodated in the swash plate chamber, wherein the swash plate is rotated by receiving a drive force from the rotary shaft and is tiltable relative to a direction perpendicular to the axis of the rotary shaft;
a piston reciprocally received in the cylinder bores; and
an actuator, which is arranged in the swash plate chamber and configured to change an inclination angle of the swash plate, wherein
the actuator includes
a partition body provided on the rotary shaft,
a movable body, which is provided in the swash plate chamber and movable along the axis of the rotary shaft, and
a control pressure chamber, which is defined by the partition body and the movable body, wherein the movable body is moved by a pressure in the control pressure chamber,
as the movable body moves along the axis of the rotary shaft, the inclination angle of the swash plate is changed such that the inclination angle of the swash plate increases when the pressure in the control pressure chamber is increased, and that the inclination angle of the swash plate decreases when the pressure in the control pressure chamber is lowered, thereby causing the piston to reciprocate by a stroke corresponding to the inclination angle of the swash plate, and
the rotary shaft receives a load acting toward the thrust bearing, the load being based on a pressure difference between the control pressure chamber and the swash plate chamber.

19. The variable displacement swash plate type compressor according to claim 18, wherein
a spacer is arranged between the cylinder block, which is arranged along the axis of the rotary shaft, and the rotary shaft, wherein the spacer is supported by the rotary shaft while being restricted from rotating and allowed to move along the axis of the rotary shaft,
the cylinder block and the spacer define a pressure-acting chamber, which communicates with the control pressure chamber, and
a sealing member is arranged between the spacer and the cylinder block, wherein the sealing member seals off the pressure-acting chamber and the swash plate chamber from each other.

20. The variable displacement swash plate type compressor according to claim 18, wherein
a spacer is provided on the rotary shaft to be integrally rotational with the rotary shaft,
the cylinder block and the spacer define a pressure-acting chamber, which communicates with the control pressure chamber, and
a sealing member is arranged between the spacer and the cylinder block, wherein the sealing member seals off the pressure-acting chamber and the swash plate chamber from each other.

21. The variable displacement swash plate type compressor according to claim 19, wherein the spacer has a contact portion, which contacts the cylinder block and is located in a vicinity of the cylinder block that is located in the axial direction of the rotary shaft.

22. The variable displacement swash plate type compressor according to any one of claim 18, wherein
the housing includes a pair of cylinder blocks,
the pair of cylinder blocks each have a cylinder bore, the cylinder bores forming a pair,
the pair of the cylinder bores reciprocally accommodates a double-headed piston, which is the piston,
the double-headed piston defines a first compression chamber in one of the pair of the cylinder bores and a second compression chamber in the other one of the pair of the cylinder bores,
a link mechanism is arranged between the rotary shaft and the swash plate, wherein the link mechanism allows change of the inclination angle of the swash plate with respect to a direction that is perpendicular to the axis of the rotary shaft,
the link mechanism is arranged such that, as the inclination angle of the swash plate is changed, a top dead center position of the double-headed piston in the second compression chamber is displaced by a greater amount than a top dead center position of the double-headed piston in the first compression chamber, and
a direction of a compression reaction force acting on the swash plate from the double-headed piston in the first compression chamber is the same as a direction of the load applied to the rotary shaft based on the pressure difference between the control pressure chamber and the swash plate chamber.

23. The variable displacement swash plate type compressor according to claim 22, wherein an outer diameter of a head of the double-headed piston accommodated in one of the pair of the cylinder bores is larger than an outer diameter of a head of the double-headed piston accommodated in the other cylinder bore of the pair.
